(19) United States
(12) Patent Application Publication
(10) Pub. No.: US 2002/0012828 A1
(43) Pub. Date: Jan. 31, 2002

(54) FUEL CELL AND GOLD-CONTAINING CATALYST FOR USE THEREIN

(76) Inventors: BOJIDARA GRIGOROVA, SANDTON (ZA); JOHN MELLOR, JOHANNESBURG (ZA); JAMES ANTHONY JUDE TUMILTY, SANDTON (ZA)

Correspondence Address: BURNS DOANE SWECKER & MATHIS L L P, POST OFFICE BOX 1404, ALEXANDRIA, VA, 22313-1404, US

(21) Appl. No.: 09/389,320

(22) Filed: Sep. 3, 1999

(30) Foreign Application Priority Data
Sep. 7, 1998 (ZA) 98/5243

(51) Int. Cl. H01M 4/90; B01J 23/52

(52) U.S. Cl. 429/40; 429/27; 429/41; 429/44; 429/46; 502/330; 502/344; 502/304

(57) ABSTRACT

A fuel cell comprises two electrodes separated by an electrolyte for conversion of a fuel and an oxidant to a reaction product. The electrode or electrodes include a catalyst comprising an oxide support preferably being a mixture of zirconium oxide and cerium oxide, having gold captured thereon in catalytically effective form. The fuel is methanol or methane.

### BACKGROUND OF THE INVENTION

This invention relates to fuel cells.

A fuel cell is a device for continuously converting chemical energy into direct-current electricity. The cell consists of two electronic-conductor electrodes separated by an ionic conducting electrolyte with provision for the continuous movement of fuel, oxidant and reaction product into and out of the cell. The fuel may be gaseous or liquid; the electrolyte liquid or solid; and the oxidant is gaseous. The electrodes are solid, but may be porous and contain a catalyst. Fuel cells differ from batteries in that electricity is produced from chemical fuels fed to them as needed.

Fuel cell technology has lagged behind that of the development of hot combustion engines, yet promises to be a contender in the sphere of small scale power generation. There are several reasons for this. For example, fuel cells can be inherently zero-emission power sources and there are a wide variety of potential fuels and oxidants available. Further, when a fuel cell driven vehicle is stationary, no fuel is used. Problems limiting the viability of fuel cells are present. For example, a suitable fuel must be available at a competitive price. Further, a suitable and cost effective catalyst is still unavailable. Base metals have been tried as catalysts but degradation of the catalyst often occurs. Platinum group metals have also been used, but sufficiently high activity at low loading has not yet been achieved.

### SUMMARY OF THE INVENTION

According to a first aspect of the invention there is provided a fuel cell comprising two electrodes separated by an electrolyte for conversion of a fuel and an oxidant to a reaction product which fuel cell is characterised in that the electrode or electrodes include a catalyst comprising an oxide support having gold captured thereon in catalytically effective form, and in that the fuel is methanol or methane.

According to a second aspect of the invention there is provided a catalyst comprising an oxide support having gold captured thereon in catalytically effective form, for use in a fuel cell comprising two electrodes separated by an electrolyte for conversion of a fuel selected from methanol or methane, and an oxidant, to a reaction product.

According to a third aspect of the invention there is provided a method of oxidising methanol or methane as a fuel for a fuel cell which is characterised in that the oxidation takes place in the presence of a catalyst comprising an oxide support having gold captured thereon in catalytically effective form.

### BRIEF DESCRIPTION OF THE DRAWINGS

FIGS. 1A and 1B are graphs of methane oxidation at various temperatures, with FIG. 1B illustrating the results of a repeat test;

FIGS. 2A and 2B are graphs of methane oxidation at various temperatures, with FIG. 2B illustrating the results of a repeat test of the catalyst K5(3); and

FIG. 3 is a graph comparing the activity of a catalyst of the invention compared to the activity of a platinum catalyst, for methanol reformation.

### DESCRIPTION OF EMBODIMENTS

Examples of preferred gold-based catalysts useful in fuel cells are those disclosed in U.S. Pat. No. 5,759,949, EP 0789621 and WO 97/45192, which are incorporated herein by reference.

One preferred form of the gold-based catalyst comprises an oxide support, preferably a mixture of cerium and zirconium oxide, a transition metal oxide, preferably cobalt oxide, to which the gold is complexed and optionally also containing an oxide of titanium or molybdenum.

The oxide support is preferably present in the catalyst in an amount of at least 50% by mass of the catalyst, and generally at least 60% by mass of the catalyst. The cerium oxide will generally constitute at least 50% by mass of the mixture of zirconium oxide and cerium oxide. The preferred mass ratio of cerium oxide to zirconium oxide is in the range 5:1 to 2:1, typically about 3:1.

The catalyst contains gold in catalytically effective form. This form will vary according to the nature of the catalyst.

The concentration of the gold will generally be low, i.e. 2% or less by mass of the catalyst.

As indicated above, the catalyst preferably also contains a transition metal in oxide form, examples being ferric oxide, or preferably cobalt oxide.

Fuels which have been found to be particularly effective and useful in the practice of the invention are methane and methanol.

The gold-based catalyst has application for both electrochemical and chemical oxidation reactions taking place in a fuel cell.

An example of a fuel cell in which a gold-based catalyst may be used is that which involves the total or partial oxidation of methane as the fuel. The ability of a number of gold-based catalysts of the type described in WO 97/45192 were tested in the oxidation of methane. The compositions which were used are set out in Table 1.

TABLE 1
Compositions of the catalysts tested for total methane
oxidation

| Code | K1 | K2 | K5(2) | K5(3) |
|---|---|---|---|---|
| Active | 1.0% Au | 1.0% Au | 1.0% Au | 1.0% Au |
| Component | 1.0% Co | 1.0% Co | 1.0% Co | 1.0% Co |
| Support | | | | |
| CeO₂ | 38% | 49% | 44% | 42% |
| CeO₂/ZrO₂ | 47.5% | 40% | 38% | 40% |
| TiO₂ | 9.5% | 10% | 15% | 15% |
| Balance- | 5.0% | 1.0% | 3.0% | 3.0% |
| other oxides | | | | |

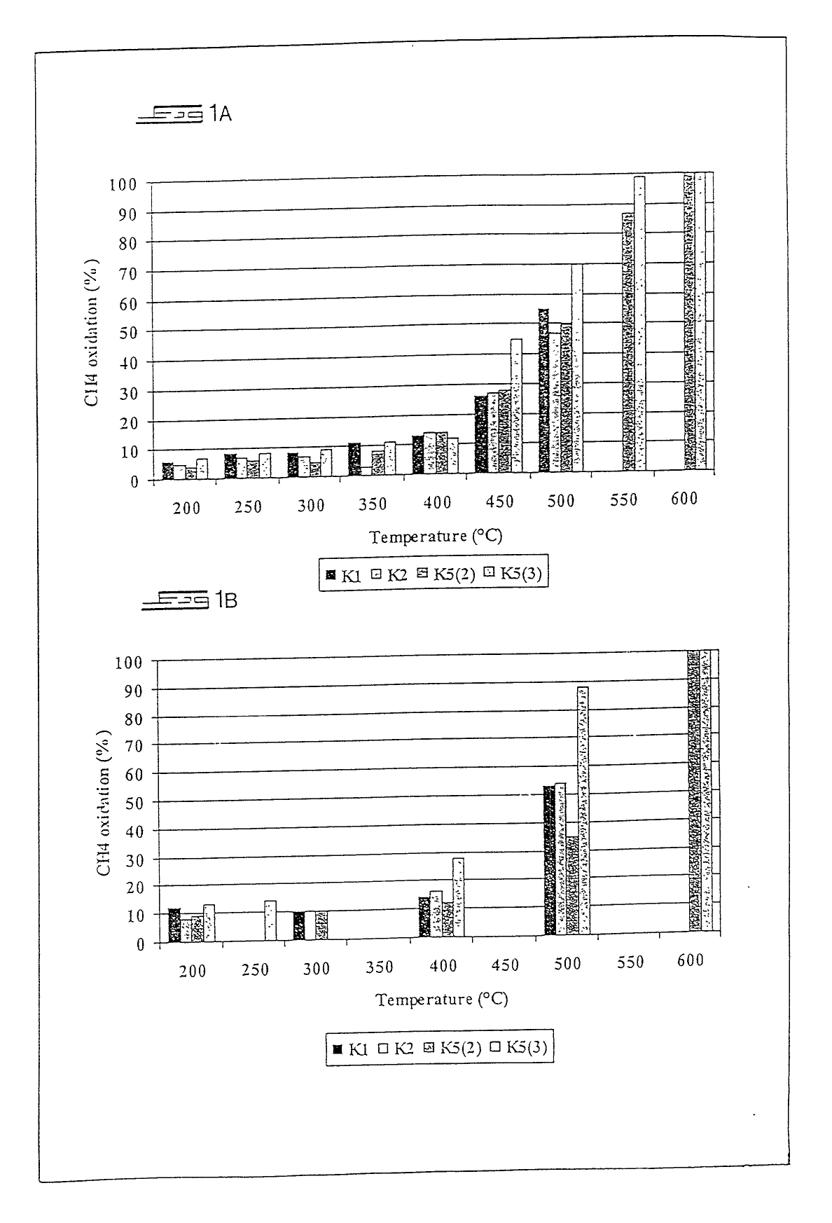

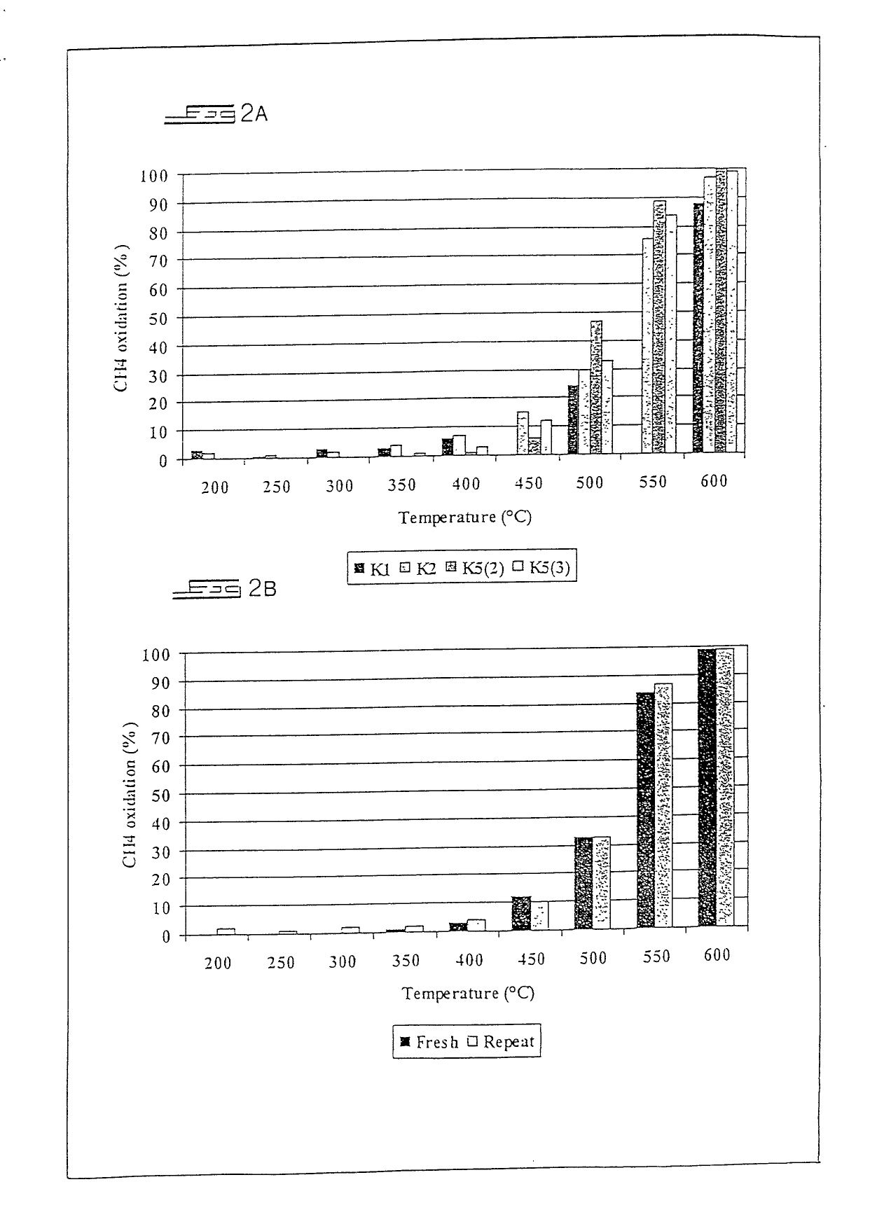

The tests were conducted with 0.25% methane (see FIG. 1), and 2.5% methane (see FIG. 2). with the balance air. The hourly space velocity of the gas mixture was 12000 h⁻¹.

Samples K1 and K2 were tested in 0.25% methane, balance air, to 500° C. and the samples K5(2) and K5(3) were tested at 600° C. After each test, the samples were cooled in air to room temperature and re-tested.

It was found that sample K5(3) gave the highest methane conversion and is stable at a temperature of 600° C.

Samples K1, K2, K5(2) and K5(3) were also tested in 2.5% methane, balance air, to 600° C.

Sample K5(3) was cooled from 600° C. in air to room temperature and re-tested in the reaction mixture to 600° C. to evaluate catalyst stability in the higher concentration of methane test gas.

It was found that the catalyst performed well in the higher concentration of methane and showed good durability.

The gold-based catalyst may also be used in a direct methanol fuel cell. Methanol is considered as a fuel of choice because of its compatibility with existing distribution networks. The results of testing carried out show that the gold-based catalyst is very active for methanol oxidation at low temperature. This is of significance as a major limitation of the commercialisation of methanol fuel cell has been the lack of catalyst for methanol oxidation at temperatures lower than 100° C.

Various gold-based catalysts of the type disclosed in WO 97/45192 were tested in their ability to catalyse the oxidation of methanol. The catalysts K2 and K5(2) were tested for methanol oxidation.

Sample K2 was evaluated in a reaction mixture containing 6.5% methanol, balance air, whilst sample K5(2) was tested in mixtures containing 6.5% and 11% methanol, balance air.

Experiments 1 and 2 were performed by pumping the required amount of liquid methanol into a vaporiser. In experiments 3, a bubbler was used to introduce methanol as this method proved to give more consistent and homogeneous reactant mixtures under the operating conditions. The operating conditions under which each sample was tested is presented in the results. Reactant and product analyses were obtained using gas chromatography.

### Results

For experiment 1 and 2 liquid methanol at the appropriate pump rate was fed into the vaporiser. The samples were cooled to 50° C. prior to the start of the reaction.

Experiment 1

| | |
|---|---|
| Sample: | K2 |
| Reactant composition: | 6,5% CH₃OH, balance air |
| Space Velocity: | 20 000h⁻¹ |
| Flowrate: | 200 ml/min |
| Sample Mass: | 0,6 g |

TABLE 1
Activity of Sample K2 for methanol oxidation as a
function of temperature

| | CH₃OH | Residual |
|---|---|---|
| Temperature | Conversion | Products |
| (° C.) | (%) | CO(%) |
| 50 | 18.8 | 0 |
| 100 | 65.6 | 0 |

Experiment 2

| | |
|---|---|
| Sample: | K5(2) |
| Reactant composition: | 6.5% CH₃OH, balance air |
| Space Velocity: | 62 600h⁻¹ |
| Flowrate: | 313 ml/min |
| Sample Mass: | 0.3 g |

TABLE 2
Activity of Sample K5(2) for methanol oxidation as a
function of temperature

| | CH₃OH | Residual |
|---|---|---|
| Temperature | Conversion | Products |
| (° C.) | (%) | CO(%) |
| 50 | 99.7 | 0 |
| 100 | 99.8 | 0 |

For experiment 3 the samples were cooled to room temperature prior to starting the reaction. Methanol was introduced at room temperature by bubbling air through the liquid methanol bubbler.

Experiment 3

| | |
|---|---|
| Sample: | K5(2) |
| Reactant composition: | 11% CH₃OH, balance air |
| Space Velocity: | 57 600h⁻¹ |
| Flowrate: | 96 ml/min |
| Sample Mass: | 0.1 g |

TABLE 3
Activity of Sample K5(2) for methanol oxidation as a
function of temperature

| | CH₃OH | Residual |
|---|---|---|
| Temperature | Conversion | Products |
| (° C.) | (%) | CO(%) |
| 44 | 99.4 | 0 |
| 50 | 100 | 0 |
| 100 | 100 | 0 |

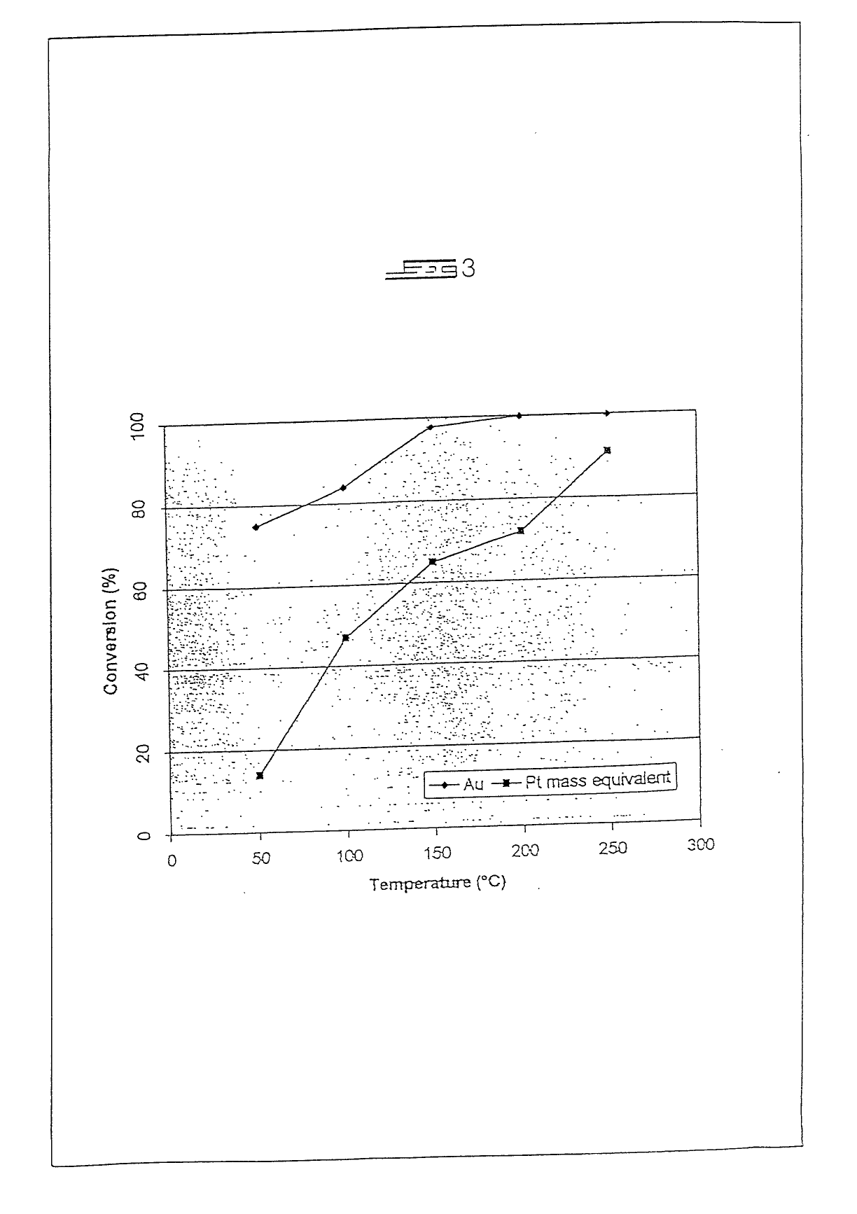

The activity of a gold catalyst of the invention for methanol reformation was compared to that of a platinum catalyst and was shown to be superior, as is indicted in FIG. 3.

We claim:

1. A fuel cell comprising two electrodes separated by an electrolyte for conversion of a fuel and an oxidant to a reaction product is characterised in that the electrode or electrodes include a catalyst comprising an oxide support having gold captured thereon in catalytically effective form, and in that the fuel is methanol or methane.

2. A fuel cell according to claim 1 wherein the catalyst comprises an oxide support being a mixture of zirconium oxide and cerium oxide having captured thereon gold in catalytically effective form, the oxide support being present in the catalyst in an amount of at least 50% by mass of the catalyst.

3. A fuel cell according to claim 2 wherein the oxide support is present in the catalyst in an amount of at least 60% by mass of the catalyst.

4. A fuel cell according to claim 2 or claim 3 wherein the cerium oxide constitutes at least 50% by mass of the mixture of zirconium oxide and cerium oxide.

5. A fuel cell according to claim 2 wherein the mass ratio of cerium oxide to zirconium oxide is in the range 5:1 to 2:1.

6. A fuel cell according to claim 1 wherein the catalyst also contains a transition metal in oxide form.

7. A fuel cell according to claim 6 wherein the transition metal oxide is selected from cobalt oxide and ferric oxide.

8. A fuel cell according to claim 7 wherein the gold is associated with the transition metal oxide.

9. A fuel cell according to claim 1 wherein the catalyst includes an oxide of titanium or molybdenum.

10. A catalyst comprising an oxide support having gold captured thereon in catalytically effective form for use in a fuel cell comprising two electrodes separated by an electrolyte for conversion of a fuel selected from methanol or methane, and an oxidant to a reaction product.

11. A catalyst according to claim 10 wherein the catalyst comprises an oxide support being a mixture of zirconium oxide and cerium oxide having captured thereon gold in catalytically effective form, the oxide support being present in the catalyst in an amount of at least 50% by mass of the catalyst.

12. A catalyst according to claim 11 wherein the oxide support is present in the catalyst in an amount of at least 60% by mass of the catalyst.

13. A catalyst according to claim 11 or claim 12 wherein the cerium oxide constitutes at least 50% by mass of the mixture of zirconium oxide and cerium oxide.

14. A catalyst according to claim 11 wherein the mass ratio of cerium oxide to zirconium oxide is in the range 5:1 to 2:1.

15. A catalyst according to claim 10 wherein the catalyst also contains a transition metal in oxide form.

16. A catalyst according to claim 15 wherein the transition metal oxide is selected from cobalt oxide and ferric oxide.

17. A catalyst according to claim 16 wherein the gold is associated with the transition metal oxide.

18. A catalyst according to claim 10 wherein the catalyst includes an oxide of titanium or molybdenum.

19. A method of oxidising methanol or methane as a fuel for a fuel cell is characterised in that the oxidation takes place in the presence of a catalyst comprising an oxide support having gold captured thereon in catalytically effective form.

20. A method according to claim 19 wherein the catalyst comprises an oxide support being a mixture of zirconium oxide and cerium oxide having captured thereon gold in catalytically effective form, the oxide support being present in the catalyst in an amount of at least 50% by mass of the catalyst.

21. A method according to claim 20 wherein the oxide support is present in the catalyst in an amount of at least 60% by mass of the catalyst.

22. A method according to claim 20 or claim 21 wherein the cerium oxide constitutes at least 50% by mass of the mixture of zirconium oxide and cerium oxide.

23. A method according to claim 20 wherein the mass ratio of cerium oxide to zirconium oxide is in the range 5:1 to 2:1.

24. A method according to claim 19 wherein the catalyst also contains a transition metal in oxide form.

25. A method according to claim 24 wherein the transition metal oxide is selected from cobalt oxide and ferric oxide.

26. A method according to claim 25 wherein the gold is associated with the transition metal oxide.

27. A method according to claim 19 wherein the catalyst includes an oxide of titanium or molybdenum.
